(19) United States
(12) Patent Application Publication
(10) Pub. No.: US 2024/0270881 A1
(43) Pub. Date: Aug. 15, 2024

(54) CROSSLINKED FLUORORESIN, CROSSLINKED FLUORORESIN PRODUCING METHOD, MOLDED BODY, AND MOLDED BODY MANUFACTURING METHOD

(71) Applicant: Proterial, Ltd., Tokyo (JP)

(72) Inventor: Hiroo KUSANO, Tokyo (JP)

(21) Appl. No.: 18/531,043

(22) Filed: Dec. 6, 2023

(30) Foreign Application Priority Data
Feb. 13, 2023 (JP) 2023-020298

(51) Int. Cl. C08F 14/26; C08J 3/24

(52) U.S. Cl. CPC C08F 14/26; C08J 3/24; C08F 2810/20; C08J 2327/18

(57) ABSTRACT

A crosslinked fluororesin includes 10 ppb or less of a perfluoro compound with 8 carbons. The crosslinked fluororesin exhibits no melt flowability when heated above a melting point of the crosslinked fluororesin. A molded body includes a base resin, and the crosslinked fluororesin mixed with the base resin. A crosslinked fluororesin producing method includes crosslinking a fluororesin by being irradiated with ionizing radiation at a temperature higher than a melting point of the fluororesin to provide a crosslinked fluororesin, and performing heat treatment on the crosslinked fluororesin to reduce a content of a perfluoro compound in the crosslinked fluororesin.

### CROSS-REFERENCE TO RELATED APPLICATIONS

The present application is based on Japanese patent application No. 2023-020298 filed on Feb. 13, 2023, the entire contents of which are incorporated herein by reference.

### TECHNICAL FIELD

This invention relates to a crosslinked fluororesin and its producing method, as well as a molded body and its manufacturing method.

### BACKGROUND OF THE INVENTION

A conventionally known molded body of fluororesin is consisting of a fluororesin and a crosslinked fluororesin obtained by irradiating the fluororesin with ionizing radiation (see Patent Literature 1). A molded body of fluororesin including the crosslinked fluororesin according to Patent Literature 1 has, due to its composition, superior abrasion resistance compared to the conventional molded body of fluororesin.
Citation List Patent Literature 1: JP2002-80672A

### SUMMARY OF THE INVENTION

In recent years, efforts have been made to achieve a low-carbon society, an advanced recycle-based society, and a society in harmony with nature in order to realize a sustainable society. In connection with these efforts, restrictions on the use of environmentally hazardous substances in products have been promoted. Under these circumstances, there is a need to improve products made from crosslinked fluororesins to be more environmentally friendly (products with less environmental impacts).

The object of the present invention is to provide a crosslinked fluororesin and its producing method that are more environmentally friendly than before, as well as a molded body including the crosslinked fluororesin and its manufacturing method that are more environmentally friendly than before.

For the purpose of solving the above problem, one aspect of the present invention provides a crosslinked fluororesin, comprising 10 ppb or less of a perfluoro compound with 8 carbons and exhibiting no melt flowability when heated above a melting point of the crosslinked fluororesin.

For the purpose of solving the above problem, another aspect of the present invention a molded body, comprising:
a base resin; and
a crosslinked fluororesin mixed with the base resin, the crosslinked fluororesin comprising 10 ppb or less of a perfluoro compound with 8 carbons being 10 ppb or less and exhibiting no melt flowability when heated above a melting point of the crosslinked fluororesin.

For the purpose of solving the above problem, still another aspect of the present invention provides a crosslinked fluororesin producing method, comprising: crosslinking a fluororesin by being irradiated with ionizing radiation at a temperature higher than a melting point of the fluororesin to provide a crosslinked fluororesin; and performing heat treatment on the crosslinked fluororesin to reduce a content of a perfluoro compound in the crosslinked fluororesin.

For the purpose of solving the above problem, a further aspect of the present invention provides a molded body manufacturing method, comprising:
the crosslinking and the heat treatment in the crosslinked fluororesin as described above; mixing the crosslinked fluororesin with a base resin to form a mixture before or after the heat treatment; and molding the mixture.

For the purpose of solving the above problem, a still further aspect of the present invention provides a molded body manufacturing method, comprising:
the crosslinking and the heat treatment in the crosslinked fluororesin as described above;
mixing the crosslinked fluororesin with a base resin to form a mixture before the crosslinking; and
molding the mixture before the crosslinking.

### Advantageous Effects of the Invention

According to the present invention, it is possible to provide a crosslinked fluororesin and its producing method that are more environmentally friendly than before, as well as a molded body including the crosslinked fluororesin and its manufacturing method that are more environmentally friendly than before.

### DETAILED DESCRIPTION OF THE INVENTION

### The First Embodiment

### (Composition of Crosslinked Fluororesin)

A crosslinked fluororesin according to a first embodiment of the present invention is a crosslinked fluororesin including at least 10 ppb or less of an 8-carbon perfluoro compound (perfluoroalkyl carboxylic acid: PFCA) and does not exhibit melt flowability even when heated above its melting point (i.e., non-melt type). It is preferable that a content rate of each of PFCAs (i.e., different types of PFCA) with 9 to 21 carbons be 25 ppb or less in the crosslinked fluororesin. This allows the crosslinked fluororesin to have a lower environmental impact, and thus a molded body (product) using this crosslinked fluororesin will have a smaller environmental impact.

The crosslinked fluororesins are fluororesins having a crosslinked structure obtained by applying the crosslinking treatment described below, to fluororesins such as tetrafluoroethylene polymer (PTFE), tetrafluoroethylene/perfluoro (alkyl vinyl ether) copolymer (PFA), tetrafluoroethylene/hexafluoropropylene copolymer (FEP), and tetrafluoroethylene/ethylene copolymer (ETFE). The crosslinked fluororesins have an improved abrasion resistance compared to those before the crosslinking treatment.

The crosslinking treatment is performed under an inactivating gas atmosphere with an oxygen concentration of 100 torr or less, more preferably 10 torr or less, at a temperature higher than the melting point of the uncrosslinked fluororesins (e.g., the melting points of uncrosslinked PTFE, PFA and FEP are 327° C., 305° C. and 275° C. respectively), with ionizing radiation at doses of 1 kGy or more and 10 MGy or less, in order to crosslink uncrosslinked fluororesins. The ionizing radiation used in the crosslinking treatment is, for example, gamma rays, electron beams, X-rays, neutron beams, or high-energy ions.

Heating a fluororesin above its melting point activates the molecular motion of the main chains constituting the fluororesin, and as a result, can efficiently promote the crosslinking reaction between the molecules. When the crosslinking reaction occurs in the fluororesin, the melting point becomes lower than it is before the crosslinking treatment is applied. When the fluororesin is irradiated with ionizing radiation at a temperature above its melting point, the crystallization heat becomes lower than it is when the fluororesin is irradiated with ionizing radiation at a temperature below its melting point before the crosslinking treatment is applied.

The crystallization heat of the crosslinked fluororesin according to the first embodiment of the present invention is 50 J/g or less. This crystallization heat is a value obtained by integrating the range of 40° C. from the rising point from the baseline on the high temperature side to the low temperature side of the heat release peak measured using a differential scanning calorimeter (DSC). To measure the crystallization heat, for example, the crosslinked fluororesin is pulverized until the average particle diameter is about 20 μm, and the measurement is performed on the obtained crosslinked fluororesin powder using a differential scanning calorimeter, while the temperature is being lowered at 20° C./min.

If the temperature of the fluororesin in the crosslinking process is lower than the melting point of the uncrosslinked fluororesin, no crosslinking reaction will occur and the fluororesin will not become a non-melt fluororesin.

As described above, the temperature of the fluororesin in the crosslinking process is set higher than the melting point of the uncrosslinked fluororesin. However, if the temperature is too high, the amount of thermal decomposition of the fluororesin increases, so it is preferable to set the temperature at which the thermal decomposition is suppressed or lower. Among the above fluororesins, PTFE has a wider temperature range than other fluororesins (10° C. or more and 30° C. or less higher than the melting point) at which sufficient crosslinking reaction occurs and the thermal decomposition is suppressed, and can be used for a stable crosslinking treatment. For this reason, it is preferable to use the crosslinked PTFE, which is a PTFE after the crosslinking treatment, as the crosslinked fluororesin according to the first embodiment of the present invention.

By performing heat treatment under predetermined conditions after the crosslinking treatment as described above, the crosslinked fluororesin according to the first embodiment of the present invention has a reduced content of PFCA, which is known as an environmentally hazardous substance. The PFCA here includes, for example, perfluoro compounds with 8 to 21 carbons.

In the first embodiment of the present invention, the content of PFCA in a crosslinked fluororesin is reduced by setting a target value for the content of PFOA (perfluorooctanoic acid) with 8 carbons, which is particularly required to be reduced among the PFCAs. For the PFCAs with 8 to 21 carbons, it is preferable to perform heat treatment at a temperature higher than the melting point of the target PFCA in order to effectively remove it, because the larger carbon number the PFCA has, the higher its melting point is.

### (Heat Treatment to Reduce PFCA Content)

Regarding the temperature of heat treatment (hereinafter also referred to as “heat treatment temperature”) for reducing the PFCA content in the crosslinked fluororesin according to the first embodiment of the present invention, it is preferable to set it to 200° C. or higher under normal pressure when reducing the content of PFCAs with 8 to 14 carbons, for example. In this case, the heat treatment temperature of 200° C. or above is sufficiently higher than the melting point of a PFCA with 8 carbons (i.e., PFOA), which has the lowest melting point among the PFCAs with 8 to 14 carbons, that is, around 52° C. to 54° C., and the melting point of a PFCA with 14 carbons (PFTeDA: perfluorotetradecanoic acid) which has the highest melting point among the PFCAs, that is, around 130° C. to 135° C. Thus, the content of the PFCAs with 8 to 14 carbons can be effectively reduced. As a result, the content of the PFCA with 8 carbons can be stably reduced to 10 ppb or less. The content of the PFCAs with 9 to 14 carbons can also be reduced to 25 ppb or less respectively. The content of the PFCAs with 15 to 21 carbons can also be reduced respectively by performing heat treatment at a temperature higher than the melting point of PFCAs with 15 to 21 carbons, as the heat treatment described above. The content of the PFCAs can be measured using LC/MS/MS (liquid chromatograph/mass spectrometer). When measuring, it is preferable to use crosslinked fluororesins in powder form with an average particle diameter of 25 μm or less.

In addition, performing the heat treatment under reduced pressure conditions such as vacuum drying lowers the melting point or a boiling point of PFCA in a crosslinked fluororesin, therefore, the concentration of PFCAs with 8 to 21 carbons can be effectively reduced.

On the other hand, if the heat treatment temperature is significantly higher than the melting point of the crosslinked fluororesin, the thermal decomposition of the crosslinked fluororesin becomes so remarkable that the quality of the crosslinked fluororesin may be significantly degraded. Therefore, it is preferable to set the upper limit of the heat treatment temperature at about 90° C. higher than the melting point of the crosslinked fluororesin. For example, if the melting point of the crosslinked fluororesin is 313° C., it is more preferable that the heat treatment temperature be 403° C. or lower. When the crosslinked fluororesin consists of crosslinked PTFE, it is more preferable that the heat treatment temperature be 340° C. or lower in order to suppress the decrease in wear resistance which has been greatly improved by crosslinking.

However, in a case of manufacturing a molded product as described below, where a crosslinked fluororesin is mixed with a base material such as an engineering plastic and then subjected to heat treatment to reduce the PFCA content, it is preferable that the heat treatment temperature be lower than the melting point of the base material to reduce thermal decomposition of the base material.

The heat treatment time can be set to an appropriate value, for example, between 5 seconds and 100 hours, to sufficiently reduce PFCAs.

The heat treatment can be performed in air or in an inert atmosphere such as a nitrogen atmosphere. Performing the heat treatment in an inert atmosphere suppresses the generation of hydrogen fluoride due to the reaction of fluorine decomposition products generated by the heat treatment with oxygen or moisture in the air, and thereby prevents contamination of the facilities and the environment. In addition, the presence of oxygen in the atmosphere accelerates thermal degradation of a resin. To suppress the thermal degradation of the crosslinked fluororesins, it is preferable to perform heat treatment under an inert atmosphere.

In addition, performing the heat treatment under a reduced pressure reduces the amount of oxygen in the atmosphere, and suppresses the generation of hydrogen fluoride due to the reaction of fluorine decomposition products and oxygen generated during the heat treatment, and thereby prevents contamination of the facilities and the environment. In addition, reducing the amount of oxygen in the atmosphere can suppress the thermal degradation of the crosslinked fluororesins.

During the heat treatment, the larger the specific surface area of the crosslinked fluororesin is, the more efficiently PFCA can be reduced. Therefore, it is preferable to perform the heat treatment onto a crosslinked fluororesin in powder form (fine-grained powder). In particular, when the heat treatment is applied to the crosslinked fluororesin in powder form, it is preferable that the average particle diameter of the powder be 25 μm or less. When the heat treatment is performed on a crosslinked fluororesin in a sheet form, it is preferable to perform the heat treatment in a reduced pressure atmosphere to increase the efficiency of PFCA reduction.

The crosslinked fluororesin after the heat treatment to reduce PFCAs can be cleaned. The cleaning can remove PFCAs present on the surface of the crosslinked fluororesin, thus a crosslinked fluororesin with further reduced PFCAs can be obtained. Water, alcohols, and organic solvents are used in the cleaning process.

### (Production Method of a Crosslinked Fluororesin)

As described above, the crosslinked fluororesin according to the first embodiment of the present invention is produced by a method that includes the crosslinking process in which the fluororesin is irradiated with ionizing radiation at a temperature higher than its melting point to obtain a crosslinked fluororesin, and the heat treatment process in which the obtained crosslinked fluororesin is heat treated to reduce the content of perfluoro compounds in the crosslinked fluororesin. In the above crosslinking process, the irradiation of ionizing radiation is carried out under a temperature higher than the melting point of the fluororesin and at an irradiation dose of 1 kGy or more to 10 MGy or less. In the above heat treatment process, the content of perfluoro compounds with 8 carbons in the crosslinked fluororesin is 10 ppb or less, and the total content of perfluoro compounds with 9 to 21 carbons in the crosslinked fluororesin is 25 ppb or less.

### (Evaluation Test)

The following describes the results of an evaluation test of the relationship between the heat treatment conditions to reduce PFCAs and the amount of PFCA reduction. In this evaluation test, a crosslinked PTFE in a form of translucent sheet with a melting point of 313° C. and an elongation of 320% was used as a crosslinked fluororesin. This crosslinked PTFE is a crosslinked PEFE sheet obtained by irradiating an uncrosslinked PTFE sheet with ionizing radiation at an irradiation dose of 100 kGy under a nitrogen atmosphere and an atmosphere temperature of 335-345° C. The thickness of the PTFE sheet before the crosslinking (uncrosslinked) was 0.5 mm, and the thickness of the crosslinked PTFE sheet after the crosslinking was 0.45 mm.

First, the crosslinked PTFE sheet was pulverized into powder with an average particle diameter of about 25 μm, and the content of PFOA (PFCA with 8 carbons) in the powder was measured. The content of PFOA was measured using LC/MS/MS (liquid chromatography/mass spectrometer).

The crosslinked PTFE sheet was pulverized by fixing the crosslinked PTFE sheet on the disk side of the ring-on-disk friction and wear tester and sliding it against the ring. The ring had roughness (incision) of 0.5 mm or more on the surface so that the crosslinked PTFE sheet could be easily pulverized (turned into wear powder). The sliding surface pressure was set to 0.5 MPa or higher and the sliding speed to 50 m/min or higher. After pulverization, coarse powder with a particle diameter of 100 μm or larger was removed, and 1 to 2 g of each powder with an average particle diameter of about 25 μm was obtained.

Table 1 below shows the measurement results of PFOA content in a crosslinked PTFE that has not been heat treated for PFCA reduction (designated as Sample A) and in crosslinked PTFEs that have been heat treated under various conditions (designated as Samples B to E). “N.D.” in the table means a measured value is less than 1 ppb, which is the detection limit of the LC/MS/MS equipment. Table 1 shows that PFOAs in the crosslinked PTFEs are reduced by the heat treatment.

TABLE 1

| | Heat Treatment Conditions | | | | Analysis Results |
|---|---|---|---|---|---|
| | Temperature | Duration | | | PFOA Amount |
| Sample | (° C.) | (h) | Atmosphere | Pressure | (ppb) |
| Sample A | — | — | — | — | 17 |
| Sample B | 200 | 12 | In the Air | Atmospheric | 6 |
| | | | | Pressure | |
| Sample C | 200 | 22 | In the Air | Atmospheric | 2 |
| | | | | Pressure | |
| Sample D | 200 | 38 | In the Air | Atmospheric | N.D. |
| | | | | Pressure | |
| Sample E | 260 | 24 | In the Air | Atmospheric | N.D. |
| | | | | Pressure | |

### (Form of Crosslinked Fluororesin)

The form of the crosslinked fluororesin according to the first embodiment of the present invention is, for example, a sheet or a powder. The following is examples of how the sheet and the powder of crosslinked fluororesin are produced.

First, prepare a sheet made of uncrosslinked fluororesin (hereinafter referred to as an “uncrosslinked fluororesin sheet”), and apply the above crosslinking treatment to make it into a sheet of crosslinked fluororesin (hereinafter referred to as a “crosslinked fluororesin sheet”). Next, apply the above heat treatment to the crosslinked fluororesin sheet to reduce PFCAs. Then the sheet of crosslinked fluororesin according to the first embodiment of the present invention can be obtained.

The crosslinked fluororesin powder according to the first embodiment of the present invention can be obtained by pulverizing the above crosslinked fluororesin sheet into a powder, or by pulverizing the above uncrosslinked fluororesin sheet and then applying the above heat treatment to it. The powder has an average particle diameter of 25 μm or less, for example. The process of pulverizing the crosslinked fluororesin sheet includes, for example, coarse crushing and subsequent fine pulverizing. The pulverizing is followed by, for example, filtering (classification) and drying.

### The Second Embodiment

A molded body according to a second embodiment of the present invention is a molded mixed material (hereinafter referred to as the “mixed material”) of the crosslinked fluororesin and the base resin according to the first embodiment described above. In other words, the molded body according to the second embodiment of the present invention includes the base resin and the crosslinked fluororesin mixed with the base resin which includes 10 ppb or less of a perfluoro compound with 8 carbons and does not exhibit melt flowability when heated above its melting point. It is preferable that the crosslinked fluororesin have a content of 25 ppb or less of each of the perfluoro compounds with 9 to 21 carbons.

As the aforementioned base resin, for example, fluororesins, nylon resins, epoxy resins, engineering plastics (including super engineering plastics), aromatic polyamide-imides, aromatic polyimides, aromatic polyesters, elastomers, and fluororubber can be used.

The fluororesins as the aforementioned base resin are, for example, PTFE, PFA, FEP, and ETFE. The engineering plastics as the aforementioned base resin are, for example, polyamideimide (PAI), polyimide (PI), nylon, polyphenylene sulfide (PPS), polyetheretherketone (PEEK), polyvinyl chloride (PVC), polyacetal (POM), and the like. The elastomers as the aforementioned base resin are, for example, nitrile rubber (NBR), ethylene propylene rubber (EPDM), silicone rubber, and so forth. Fluoroelastomers as the aforementioned base resin are, for example, rubbers made of crosslinked copolymers composed of ethylene tetrafluoride and polyolefin, and the like.

The molded body according to the embodiments of the present invention typically includes a PTFE as the base resin and a crosslinked PTFE mixed with the PTFE.

By mixing the above-mentioned crosslinked fluororesin according to the first embodiment with the base resin, abrasion resistance can be imparted to the base resin. In order to effectively impart the abrasion resistance to the base resin, it is preferable to mix 2 to 500 parts by weight of the crosslinked fluororesin according to the first embodiment with respect to 100 parts by weight of the base resin. Considering the extrudability of the mixed material, it is preferable that the melt viscosity of the mixed material be less than 30000 Pa·s.

### (Manufacturing Method of Molded Body)

A manufacturing method of a molded body according to the second embodiment of the present invention includes the crosslinking process and the heat treatment process in the producing method of crosslinked fluororesin according to the first embodiment, the mixing process of mixing the above crosslinked fluororesin with a base resin to form a mixture before or after the heat treatment process, and the molding process of molding the obtained mixture. Before the mixing process, it is preferable to have a pulverizing process in which the crosslinked fluororesin to be mixed with the base resin is pulverized to a powder. Making the crosslinked fluororesin into a powder facilitates mixing it into the base resin. It is preferable that the average particle diameter of the powdered crosslinked fluororesin be 25 μm or less.

Additionally, another manufacturing method of a molded body according to the second embodiment of the present invention includes the crosslinking process and the heat treatment process in the producing method of the crosslinked fluororesin according to the first embodiment, and further includes, before the crosslinking process, the mixing process of mixing the crosslinked fluororesin with the base resin to form a mixture, and the molding process of molding the obtained mixture. In other words, according to this producing method, an uncrosslinked fluororesin is mixed with the base resin to form a mixture, the mixture is molded into a predetermined shape, and then the above-mentioned crosslinking process and heat treatment process are applied to obtain a molded body including the crosslinked fluororesin. It is preferable that the uncrosslinked fluororesin to be mixed with the base resin be a powdered fluororesin. The powdered fluororesin should have an average particle diameter of 25 μm or less. This makes it easier to mix the fluororesin into the base resin.

### (Form of Molded Body)

A form of the molded body according to the second embodiment of the present invention is, for example, a pellet-shaped molded body, a linear-shaped molded body such as a string or a tube, a block-shaped molded body, a sheet or tape-shaped molded body, and a molded body consisting of a coating material covering the surface of a base material. The following explains an example of a manufacturing method for each form.

### Pellet-Shaped Molded Body

First, make a mixed material by mixing the crosslinked fluororesin according to the first embodiment of the present invention with the base resin. Specifically, mix the powder of the crosslinked fluororesin according to the embodiment of the present invention and the base resin, feed the mixed material into a twin-screw kneading extruder, and extrude it into a string shape while heating and melting. Then form the extruded mixed material into pellets using a pelletizer. This produces a pellet-shaped molded body according to the embodiment of the present invention.

### Linear-Shaped Molded Body

Extrude the above pellet-shaped molded body into a linear shape using an extrusion molding machine. This produces the linear-shaped molded body according to the embodiment of the present invention.

### Block-Shaped Molded Body

Form the above pellet-shaped molded body into a block shape using a press molding machine, extrusion molding machine, or injection molding machine, or the like. Here, a block shape is a mass having a rectangular, cylindrical, or other shape. This produces a block-shaped molded body according to the embodiment of the present invention.

### Sheet or Tape-Shaped Molded Body

Form the aforementioned block-shaped molded body into sheets by cutting. Alternatively, the aforementioned pellets can be formed into a sheet shape using an extrusion molding machine or the like. This produces a sheet-like molded body according to the embodiment of the present invention. The sheet-like molded body may also be processed by punching, etching, attaching adhesive portions of adhesive tape, laminating with rubber sheets, or other processes. The sheet-shaped molded body may also be made into a tape-like molded body by connecting sheets using an adhesive or the like to the sheet-shaped molded body.

### Coating Material

Make a coating material by dispersing a base resin and a powdered crosslinked fluororesin in an aqueous solution or solvent or the like, and apply it to the surface of a base material consisting of a plate or cylindrical metal member or a cylindrical resin tube or the like. As a result, a molded body of the embodiment of the present invention is formed on the surface of the base material as a coating material. As the coating method, spraying, electrostatic powder coating, or impregnation can be used, for example. When a base material is glass cloth, for example, apply the above coating material by impregnation to form a coating on the surface of the base material. Additionally, a coating material including a base resin and a powdered uncrosslinked fluororesin can be used for coating the base material, and a molded body can be made by performing the crosslinking and heat treatment described above on the applied coating material.

### Advantageous Effects of the Embodiments

According to the first and second embodiments of the present invention, it is possible to provide a crosslinked fluororesin that has excellent wear resistance and is more environmentally friendly than the conventional one by effectively reducing PFCA contained in the crosslinked fluororesin. In addition, by mixing the crosslinked fluororesin with the base resin, it is possible to provide a molded body with excellent abrasion resistance and more environmentally friendly than before.

### SUMMARY OF THE EMBODIMENTS

Next, we will describe the technical ideas understood from the aforementioned embodiments. However, the following description does not limit the constituent elements in the scope of claims to the members and the like specifically shown in the embodiments.

According to the first feature, a crosslinked fluororesin contains 10 ppb or less of a perfluoro compound with 8 carbons and does not exhibit melt flowability even when heated above its melting point.

According to the second feature, in the crosslinked fluororesin as described in the first feature, each of perfluoro compounds with 9 to 21 carbons has the content of 25 ppb or less.

According to the third feature, the crosslinked fluororesin as described in the first feature is a crosslinked PTFE.

According to the fourth feature, a molded body includes a base resin and a crosslinked fluororesin mixed with the base resin, and the crosslinked fluororesin contains 10 ppb or less of a perfluoro compound with 8 carbons and does not exhibit melt flowability when heated above its melting point.

According to the fifth feature, in the molded body as described in the fourth feature, the crosslinked fluororesin is a crosslinked PTFE.

According to the sixth feature, a crosslinked fluororesin producing method includes a crosslinking process in which a fluororesin is irradiated with ionizing radiation at a temperature higher than its melting point to obtain a crosslinked fluororesin; and a heat treatment process in which the crosslinked fluororesin is heat treated to reduce the content of perfluoro compounds contained in the crosslinked fluororesin.

According to the seventh feature, in the crosslinked fluororesin producing method as described in the sixth feature, the content of perfluoro compounds with 8 carbons in the crosslinked fluororesin is reduced to 10 ppb or less in the heat treatment process.

According to the eighth feature, in the crosslinked fluororesin producing method as described in the sixth feature, each of the perfluoro compounds with carbon numbers from 9 to 21 in the crosslinked fluororesin has the content of 25 ppb or less after the heat treatment.

According to the ninth feature, in the crosslinked fluororesin producing method as described in the sixth feature, the crosslinked fluororesin is a crosslinked PTFE.

According to the tenth feature, a molded body manufacturing method includes the crosslinking process and the heat treatment process in the method of producing a crosslinked fluororesin as described in any one of the sixth to ninth features; and a mixing process for mixing the crosslinked fluororesin with the base resin to form a mixture and a molding process for molding the mixture before or after the heat treatment process.

According to the eleventh feature, a molded body manufacturing method includes the crosslinking process and the heat treatment process in the method of producing a crosslinked fluororesin as described in any one of the sixth to ninth features; a mixing process in which the base resin is mixed with the fluororesin to form a mixture before the crosslinking process; and a molding process in which the mixture is molded before the crosslinking process.

That is all for the description of the embodiments of the present invention. This invention is not limited to the above embodiments, but various modifications can be made without departing from the scope and spirit of the invention. Also, the embodiments do not limit the invention according to the scope of claims. Additionally, it should be noted that not all combinations of features described in the embodiments are essential to the means for solving problems of the invention.

1. A crosslinked fluororesin, comprising 10 ppb or less of a perfluoro compound with 8 carbons and exhibiting no melt flowability when heated above a melting point of the crosslinked fluororesin.

2. The crosslinked fluororesin according to claim 1, wherein a content of each of perfluoro compounds with 9 to 21 carbons is 25 ppb or less.

3. The crosslinked fluororesin according to claim 1, wherein the crosslinked fluororesin is a crosslinked PTFE.

4. A molded body, comprising:
a base resin; and
a crosslinked fluororesin mixed with the base resin, the crosslinked fluororesin comprising 10 ppb or less of a perfluoro compound with 8 carbons being 10 ppb or less and exhibiting no melt flowability when heated above a melting point of the crosslinked fluororesin.

5. The molded body according to claim 4, wherein the crosslinked fluororesin is a crosslinked PTFE.

6. A crosslinked fluororesin producing method, comprising:
crosslinking a fluororesin by being irradiated with ionizing radiation at a temperature higher than a melting point of the fluororesin to provide a crosslinked fluororesin; and
performing heat treatment on the crosslinked fluororesin to reduce a content of a perfluoro compound in the crosslinked fluororesin.

7. The crosslinked fluororesin producing method according to claim 6, wherein the content of the perfluoro compound with 8 carbons in the crosslinked fluororesin is reduced to 10 ppb or less in the heat treatment.

8. The crosslinked fluororesin producing method according to claim 6, wherein a content of each of perfluoro compounds with 9 to 21 carbons in the crosslinked fluororesins is 25 ppb or less after the heat treatment.

9. The crosslinked fluororesin producing method according to claim 6, wherein the crosslinked fluororesin is a crosslinked PTFE.

10. A molded body manufacturing method, comprising:
the crosslinking and the heat treatment in the crosslinked fluororesin according to claim 6;
mixing the crosslinked fluororesin with a base resin to form a mixture before or after the heat treatment; and
molding the mixture.

11. A molded body manufacturing method, comprising:
the crosslinking and the heat treatment in the crosslinked fluororesin according to claim 6;
mixing the crosslinked fluororesin with a base resin to form a mixture before the crosslinking; and
molding the mixture before the crosslinking.
